(19) United States
(12) Patent Application Publication
(10) Pub. No.: US 2009/0269516 A1
(43) Pub. Date: Oct. 29, 2009

(54) ARTIFICIAL STONE-DECORATED GLAZED PRODUCT

(75) Inventor: Ching-Liang CHU, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Rong Jih Marble Enterprise Co., Ltd, Shigang Twonship (TW)

(21) Appl. No.: 12/111,279

(22) Filed: Apr. 29, 2008

(51) Int. Cl. B44F 7/00

(52) U.S. Cl. 428/15

(57) ABSTRACT

Showing the natural beauty of the combination of stone and a glazed product, an artificial stone-decorated glazed product is disclosed having an artificial stone material formed of a resin and a hardening agent and a stone power in a glazed product substrate in integrity. The artificial stone material has a grain portion distributed in the glazed product substrate to show a drag structure.

### BACKGROUND OF THE INVENTION

1. Field of the Invention

The present invention relates to glazed products and more particularly, to an artificial stone-decorated glazed product.

2. Description of the Related Art

A glazed product is an art piece made of different colors of artificial crystal by means of a de-waxing casting technique through a high-temperature sintering process. The fabrication of a glazed product is complicated. The fabrication requires several tens of manual steps. A glazed product has the creator's design in it. It shows the traditional and modern Chinese cultural characteristics. Glazed products can be used in different places for decoration.

However, the preparation of a glazed product requires much time and labor. The sintering process is performed under a high temperature condition. The temperature and time control determines the fineness of the finished product. To solve the problems of the conventional glazed products fabrication method, a rapid and effective fabrication technique is developed. This substitute method uses a transparent resin as the base material, and adds pigments and a hardening agent to the transparent resin to color the transparent resin and to harden the transparent resin. This method is quite simple, and practical for mass production to lower the cost. A product made according to this method shows the outer appearance of a real glazed product, meeting all decoration requirements.

However, the aforesaid substitute method cannot achieve certain glazed structure designs. For example, stones or insects may be incorporated in a glazed product to show the power of life or to extend the imagination of the design. However, because stones or insects are bonded to the glazed product at selected locations, the interrupted distribution of the stones or insects does not cause a natural sense of beauty, lowering the commercial value of the product. Therefore, a product made according to this method does not meet the requirement for high grade decoration.

### SUMMARY OF THE INVENTION

The present invention has been accomplished under the circumstances in view. It is therefore one object of the present invention to provide a stone-decorated glazed product, which has a drag structure-like grain to cause a natural sense of beauty and to enhance the commercial value.

To achieve this and other objects of the present invention, the stone-decorated glazed product comprises a glazed product substrate and an artificial stone material. The artificial stone material is formed in the glazed product substrate, comprising a grain portion distributed in the glazed product substrate to show a drag structure. The artificial stone material is prepared from a resin, a hardening agent, and a stone powder. The artificial stone-decorated glazed product shows the natural beauty of the combination of stone and a glazed product that match each other perfectly.

### BRIEF DESCRIPTION OF THE DRAWING

FIG. 1 is a schematic top plain view of an artificial stone-decorated glazed product in accordance with the present invention.

### DETAILED DESCRIPTION OF THE INVENTION

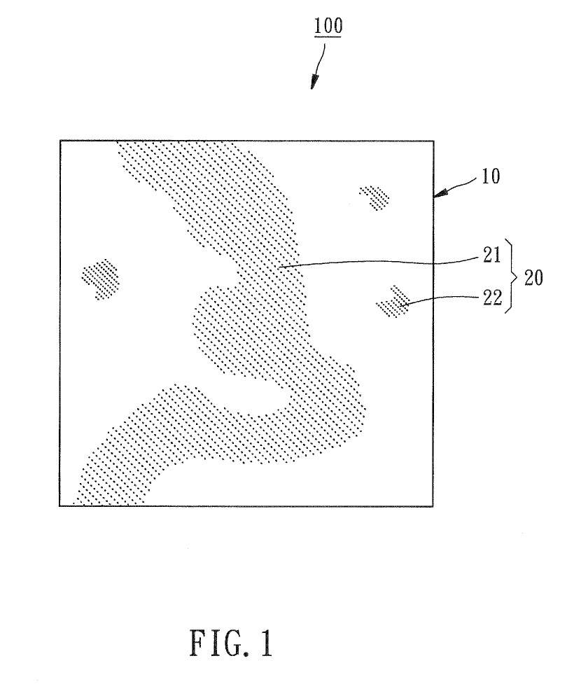

Referring to the annexed drawing of FIG. 1, an artificial stone-decorated glazed product 100 in accordance with the present invention is shown comprising a glazed product substrate 10, and an artificial stone material 20 formed in the glazed product substrate 10 in integrity. The artificial stone material 20 comprises a grain portion 21 distributed in the glazed product substrate 10 to show a drag structure, and a plurality of non-drag decorative portions 22 distributed in the glazed product substrate 10 beyond the area of the grain portion 21.

The formation of the glazed product substrate 10 and the artificial stone material 20 is outlined hereinafter. The glazed product substrate 10 is formed of a first fluid material that is prepared by mixing a resin with a hardening agent and a pigment and controlled in a fluid condition. The artificial stone material 20 is formed of a second fluid material that is prepared by mixing a resin with a hardening agent and a stone powder (or insects). Under a low temperature condition, the first fluid material and the second fluid material are mixed. During mixing, part of the stone powder is distributed subject to the flow trace of the resin and hardening agent in the second fluid material. Alternatively, said part of the stone powder is distributed subject to the flow trace of the resin and hardening agent in the second fluid material and the resin and hardening agent in the first fluid material. Therefore, when the mixture of the first fluid material and second fluid material is hardened, the stone powder constitutes the desired grain portion 21 that shows a drag-like structure. Further, when mixing the first fluid material and the second fluid material, part of the stone powder is distributed in the first fluid material to constitute the desired non-drag decorative portions 22. When desired, stone chips may be inserted into the mixture at selected locations.

An artificial stone-decorated glazed product made according to the aforesaid fabrication method has an artificial stone material formed in the glazed product substrate in integrity. Further, the artificial stone material comprises a grain portion distributed in the glazed product substrate to show a drag structure, and a plurality of non-drag decorative portions distributed in the glazed product substrate beyond the area of the grain portion. The artificial stone-decorated glazed product shows the natural beauty of the combination of stone and a glazed product that match each other perfectly. When compared to conventional glazed products that have stone chips embedded therein to show a non-drag pattern, the invention has a relatively higher commercial value and meet all requirements for excellent beauty decorations. Therefore, the invention can be widely used in places for decoration.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An artificial stone-decorated glazed product comprising:
a glazed product substrate; and
an artificial stone material formed in said glazed product substrate, said artificial stone material comprising a grain portion distributed in said glazed product substrate to show a drag structure, said artificial stone material containing a resin, a hardening agent, and a stone powder.

2. The artificial stone-decorated glazed product as claimed in claim 1, wherein said artificial stone material further comprises at least one non-drag decorative portion distributed in said glazed product substrate beyond the area of said grain portion.

3. The artificial stone-decorated glazed product as claimed in claim 1, wherein said glazed product substrate and said artificial stone material are formed in integrity.

4. The artificial stone-decorated glazed product as claimed in claim 2, wherein said glazed product substrate and said artificial stone material are formed in integrity.

5. The artificial stone-decorated glazed product as claimed in claim 1, wherein said glazed product substrate is formed by means of hardening a first fluid material, said first fluid material containing a resin and a hardening agent; said artificial stone material is formed by means of hardening a second fluid material, said second fluid material containing a resin, a hardening agent, and a stone powder, said stone power having a part thereof bonded to the resin and hardening agent of said second fluid material to form said drag structure of said grain portion.

6. The artificial stone-decorated glazed product as claimed in claim 1, wherein said glazed product substrate is formed by means of hardening a first fluid material, said first fluid material containing a resin and a hardening agent; said artificial stone material is formed by means of hardening a second fluid material, said second fluid material containing a resin, a hardening agent, and a stone powder, said stone power having a part thereof bonded to the resin and hardening agent of said second fluid material and the resin and hardening agent of said first fluid material to form said drag structure of said grain portion.

7. The artificial stone-decorated glazed product as claimed in claim 5, wherein said stone power having a part thereof distributed in the resin of said first fluid material to form said at least one non-drag decorative portion.

8. The artificial stone-decorated glazed product as claimed in claim 6, wherein said stone power having a part thereof distributed in the resin of said first fluid material to form said at least one non-drag decorative portion.
